(19) United States
(12) Patent Application Publication
(10) Pub. No.: US 2001/0018856 A1
(43) Pub. Date: Sep. 6, 2001

(54) Positioning device for parts to be cut, such as a tile

(76) Inventor: Jean-Marie Fouy, La Baule (FR)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 09/754,087

(22) Filed: Jan. 5, 2001

(30) Foreign Application Priority Data
Jan. 7, 2000 (FR) 0000156

(51) Int. Cl. B27B 5/29

(52) U.S. Cl. 83/467.1; 83/477.2

(57) ABSTRACT

A device for positioning a part to be cut placed on the bed of a cutting machine has an angular positioner provided, on the one hand, with means for sliding in a plane parallel to the plane of said bed and in a translational guidance direction parallel to the cutting plane of a cutting tool of said cutting machine, and, on the other hand, with means for positioning the part to be cut relative to said plane of said cutting tool in a plurality of special, defined angular positions.

The present invention concerns a positioning device for tiles, designed to be used on a cutting machine, for example, a cutting machine with a circular cutting tool.

Such cutting machines usually include a bed through which the cutting tool protrudes. A guide plate is provided to be mounted on the bed so as to be positioned parallel to the cutting plane of the tool, at a predefined variable distance therefrom.

A part to be cut, for example, a flat ceramic tile, is placed on the bed of the machine, then one of its edges is brought into contact against a reference edge of the guide plate facing the cutting tool. It is then pushed against the cutting tool, which was previously set in rotation, so as to hold the tile in sliding contact with the reference edge of the guide plate.

It is understood that the guide plate may sometimes be fixedly mounted on the bed to prevent its moving during the cutting of the tile.

The tile is thus cut parallel to the edge of said tile which slides against the guide plate. The width of the part of the tile thus cut is equal to the specific predefined distance separating the edge of the guide plate facing the cutting tool and the cutting tool itself.

However, it sometimes happens that one wishes to cut the tile other than parallel to one of its edges. It is then possible to use an angled stop which can be mounted to slide on the guide plate along its edge facing the cutting tool. This type of angled stop usually includes a dihedron formed by two perpendicular surfaces which are respectively designed to accommodate the two adjacent edges forming a corner of a tile to be cut.

The tile is then placed on the bed with one corner in contact with the perpendicular edges of the of the angled stop; then, it is moved against the cutting tool while being guided in the angled stop which slides along the guide plate.

The position of the cutting line of the tile is determined, on the one hand, by the distance separating the guide plate from the cutting tool and, on the other, by the angular position of the dihedron of the angular stop relative to the guide plate.

This angular position of the dihedron of the angular stop is unique. Frequently, the bisector of the two perpendicular surfaces of the dihedron is perpendicular to the guide plate.

However, although this type of cutting is frequently used, it is advantageous to be able to rapidly position parts to be cut on the bed of the cutting machine in other special angular positions.

The object of the invention is thus to propose a positioning device for a cutting machine which enables cutting tiles in numerous special positions.

To this end, the device for positioning a part to be cut placed on the bed of a cutting machine is noteworthy in that it includes an angular positioner which is provided, on the one hand, with means for sliding in a plane parallel to the plane of said bed and in a translational guidance direction parallel to the cutting plane of a cutting tool of said cutting machine and, on the other, with means for positioning the part to be cut relative to said plane of said cutting tool in a plurality of special, defined angular positions.

Thus, the positioning device of the invention enables tile cutting in a large number of special, defined positions.

According to another characteristic of the invention, the angles formed respectively by said angular positions with the translational guidance direction are multiples of 5°.

The angular positioner is also provided with facets, and according to another characteristic of the invention, said means for positioning the part to be cut relative to said plane of said cutting tool in a plurality of special, defined angular positions are made up of two of said facets perpendicular to each other with each forming a special, defined angle relative to said translational guidance direction.

According to another characteristic of the invention, the angular positioner is also made up of a concave polygonal base associated laterally at each of its cardinal points with a stop consisting of a polyhedron, with the means for positioning the part to be cut relative to said plane of said cutting tool in a plurality of special, defined angular positions made up, on the one hand, of edges of the concave polygon of the base and, on the other, of facets of the polyhedron of each of the stops which are perpendicular to each other in pairs.

According to another characteristic of the invention, each of the edges of the concave polygon of the base forms a special, defined angle with a translational guidance direction on a guide plate, with said guide plate being provided to be mounted on said bed parallel to the direction parallel to the cutting plane of a cutting tool.

According to another characteristic of the invention, the angular positioner is provided to be mounted to slide on the guide plate.

According to another characteristic of the invention, the angular positioner includes, to ensure its translational guidance on the guide plate, corner facets arranged on each of the stops in the portion which straddles the base.

According to another characteristic of invention, the translational guidance direction on the guide plate is implemented as a reference plane of the angular positioner passing through one of the four planes formed by said corner facets, with said reference plane selected as that nearest the edge in question, with each stop partially overlapping the base by its median plane.

According to another characteristic of the invention, the planes formed respectively by the corner facets are separated, with minimal clearance, by a distance equal to the width of the guide plate so as to permit sliding guidance of the angular positioner on the guide plate.

According to another characteristic of the invention, legs positioned at each of the ends of the guide plate have notches which are provided to engage respectively with teeth formed on the lateral edges of the bed.

According to another characteristic of the invention, the teeth have a trapezoidal shape.

According to another characteristic of the invention, the pitch of the teeth is equal to three times the pitch of the notches.

The aforementioned characteristics of the invention, as well as others, will become clearer through the reading of the following description of an exemplary embodiment, with said description made with reference to the attached drawings, wherein:

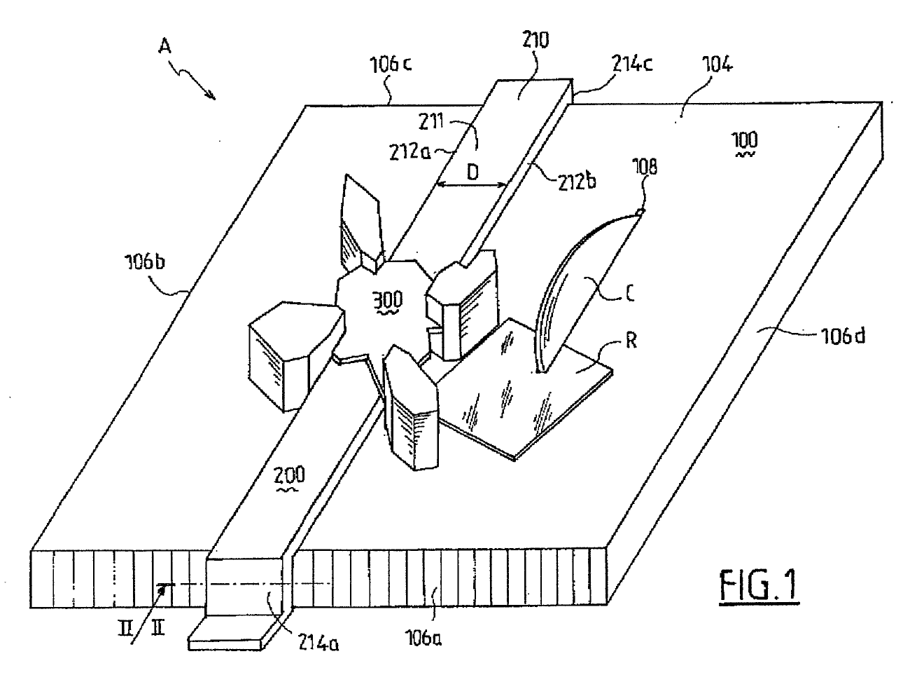

FIG. 1 is a perspective view of a device for positioning parts to be cut, mounted on a bed of a cutting machine according to the invention,

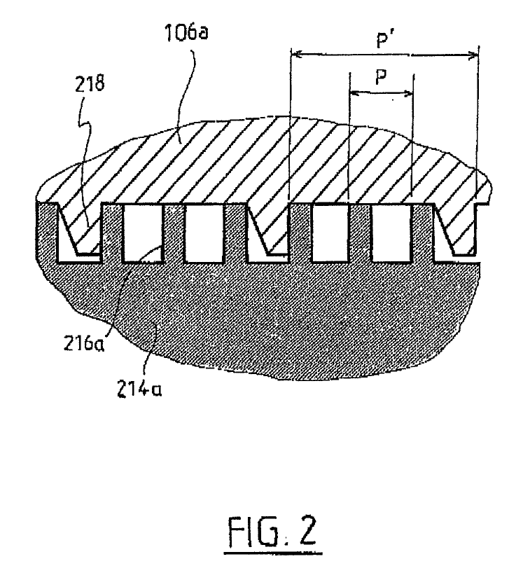

FIG. 2 is a sectional view of one end of a guide plate of a device for positioning parts to be cut, mounted on a bed of a cutting machine according to the invention, and

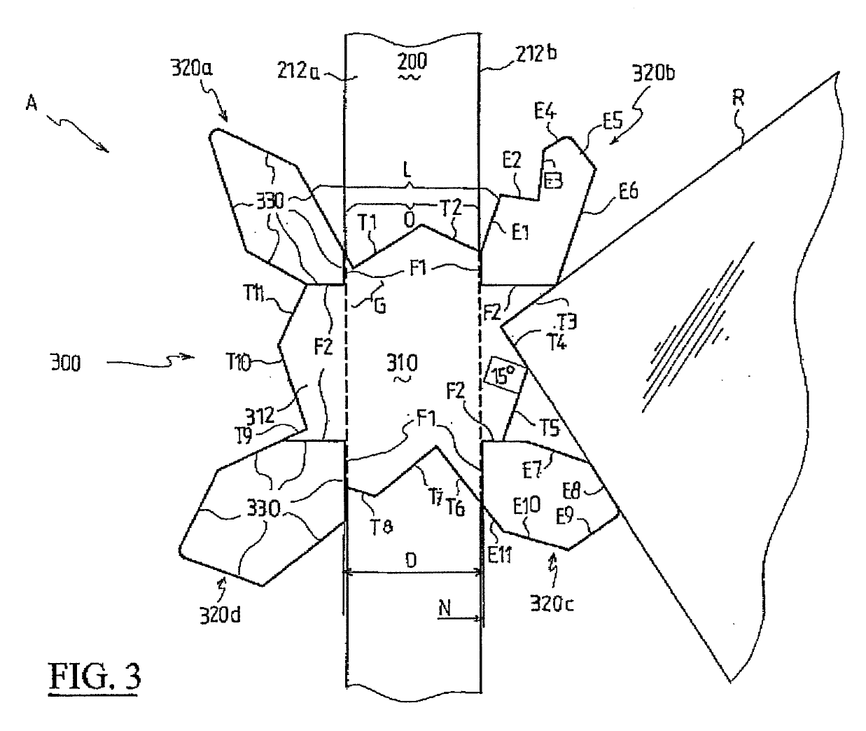

FIG. 3 is a top view of a device for positioning parts to be cut, mounted on a bed of a cutting machine according to the invention.

The device A for positioning a part to be cut R, such as a ceramic tile, depicted in FIG. 1, includes a guide plate 200 and an angular positioner 300. The positioning device A is designed to be positioned on a bed 100 of a cutting machine.

The bed 100 is made up of a plate of which a flat top surface 104 is designed to support said part to be cut R. The plate is bounded by four lateral edges 106a, 106b, 106c, 106d, and is provided with a cutout 108, through which protrudes a cutting tool C, for example, a circular cutting tool, such as that represented in this FIG. The cutting plane which can be generated by this tool is perpendicular to the lateral edges 106a and 106c.

The guide plate 200 rests on the top surface 104 of the bed 100. It consists of a rectilinear bar 210 which also has, in particular, a top edge 211, as well as two lateral edges 212a and 212b. Its width has a value D.

The guide plate 200 terminates at each end in a leg 214a or 214c, respectively. In FIG. 2, the legs 214a or 214c have notches 216a and 216c, respectively, of which only the notch 216a is depicted, and which are formed on their exposed faces facing each other. The notches 216a and 216c of one and the same face have a pitch P. These notches 216a and 216c can engage respectively with the teeth 218 formed on the lateral edges 106a and 106c. The teeth 218 preferably have a trapezoidal cross-section, and their pitch P′ is equal to three times the pitch P of the notches 216a, 216c.

Thus, the positioning and retention in position of the guide plate 200 on the bed 100 perpendicular to the cutting plane which the cutting tool C can generate are realized by lifting it and engaging it vertically at the position desired. The positioning precision is thus equal to the pitch P.

The angular positioner 300 is designed to be mounted astraddle the guide plate 200, as depicted in FIG. 3.

In this FIG. , the angular positioner 300 consists of a base 310 associated laterally, and at its cardinal points, with four stops 320a-d.

The base 310 with a more or less constant thickness has a perimeter in the shape of a concave polygon whose edges T form, in pairs, salient or reentrant angles. It is designed to rest and to be moved on its front surface 312 or its flipside 314 (not visible in this FIG. ) on the top edge 211 of the rectilinear bar 210.

Each stop 320a-d has the shape of a polyhedron which partially straddles the base 310 with its median plane. The height of the stops 320a-d from the front surface 311 or the flipside 314 is more or less equal to the height of the lateral edges 212a or 212b of the guide plate 200.

Means of angular positioning L of the part to be cut R relative to the guide plate 200 are provided on the angular positioner 300 or on the guide plate 200.

More precisely, these angular positioning means L enable angular positioning in a plurality of special, defined angular positions of the part to be cut R relative to the guide plate 200 and, consequently, relative to the plane of the cutting tool C.

These means L consists in particular of means for guiding by sliding G along a cutting direction which is parallel to the cutting plane of the tool C. In a preferred embodiment, these means for guiding by sliding G consist of corner facets F1 and F2 in the number of two per stop 320 and thus forming two of the facets 330 of the polyhedron of a stop 320. These corner facets F1 and F2 form the part of each of the stops 320a-d which straddles the base 310 and are designed to enable the angular sliding positioning of the positioning device A on the guide plate 200.

FIG. 3 shows that each of the corner facets F1 or F2 of a first stop 320 is located in the same plane or is parallel or perpendicular to each of the corner facets F1 or F2 of an adjacent stop 320. For example, the corner facet Fl of the stop 320a is located in the same plane parallel to the corner facet F1 of the stop 320b.

The planes formed respectively by the corner facets F1 and F2 are separated, with minimal clearance, by a distance equal to the width D of the guide plate 200. Thus, when the angular positioner 300 is mounted astraddle the guide plate 200, i.e., when it rests on its base 310 on said guide plate 200, the corner facets F1 enable sliding guidance of the positioning device A on the lateral edges 212a and 212b of the guide plate 200.

It is likewise discernible that the angular positioner 300 can be mounted astraddle the guide plate 200 according to two positions offset from each other by an angle of 180° passing through the plane of the base 310.

The corner facets F2, for their part, enable the positioning of the positioning device A with an angular offset of 90° relative to the angular positioning enabled by the corner facets F1.

Since the corner facets F1 and F2 straddle the base 310 from end to end with its front face 312 and its flipside 314, the angular positioner 300 may be turned over and can thus assume eight special positions when it is mounted astraddle the guide plate 200.

The angular positioning means L of the part to be cut R relative to the guide plate 200 also consist of orientation means O of the part to be cut R provided on the positioning device A. These orientation means enable positioning the part to be cut R relative to said plane of said cutting tool C.

These orientation means O include, on the one hand, edges T of the concave polygon of the base 310, of which there are eleven in FIG. 3, labeled with reference characters T1 through T11, and, on the other, other facets 330 of the polyhedron, distinct from the corner facets F1 and F2, and consisting of facets E.

The orientation means O are referenced at an angle relative to the reference plane N as follows:

Each edge T1-T11 forms a specific angle with a reference plane N passing through either the corner facets F1 or through the corner facets F2. The reference plane considered is the plane nearest said edge T in question.

For example, in FIG. 3, the edge T5 forms an angle of 15° relative to the plane passing through the corner facets F1.

The value of each of these angles is advantageously inscribed on the base 310 near each of the edges T. In FIG. 3, the number 15° appears near the edge T5.

In a preferred embodiment, the values of the angles formed between the edges T and the corner facets F1 or F2 are multiples of five degrees.

For better positioning of the part to be cut R in the angular positioner 300, each of the edges T1-T11 is extended in the same plane by a facet E of a polyhedron of a stop 320.

For reasons of clarity, only the facets E1 through E10 of the polyhedrons of the stops 320b and 320c of the angular positioner 300 are referenced in FIG. 3.

For example, the edge T4 is extended by the facet E8.

Each edge T also forms a right angle with a second facet E of the polyhedron of a stop 320. For example, the edge T5 forms a right angle with the facet E7. With this construction, it is possible to position the adjacent edges forming the corner of the part to be cut R respectively against an edge T extended by a facet E and another facet E of the angular positioner 300.

By properly positioning the angular positioner 300 astraddle the guide plate 200, i.e., by placing one of the reference planes N of the angular positioner 300 against the lateral edge 212b, it is possible to orient the part to be cut R on the angular positioner 300 in special angular positions where its adjacent edges are not parallel to said guide plate 200.

The guide plate 200 is positioned on the bed 100 of the cutting machine at a specific distance from the cutting tool C, for example, using a ruler.

The angular positioner 300 is mounted astraddle the guide plate 200 in a specific position. To achieve this, the cutting angle which the cutting line

made by the cutting tool C must form with one of the edges of the part to be cut R is defined. Then, the inscribed value of this angle is found on the base 310, and the angular positioner 300 is positioned on the guide plate 200 such that the edge T corresponding to this value is positioned between the guide plate 200 and the cutting tool C.

Then, the adjacent edges forming the corner of a part to be cut R are placed in contact against the edge T and the facet E perpendicular to said edge T of the angular positioner 300, respectively.

Next, the part to be cut R positioned in the positioning device A is moved toward the cutting tool C previously turned on; then, the part to be cut R is cut.

The positioning device of the invention enables cutting parts to be cut R other than parallel to each of their sides.

Specifically, it enables cutting parts to be cut R at a special angle relative to one of its edges.

1. Positioning device for a part to be cut placed on a bed of a cutting machine, wherein said positioning device includes an angular positioner provided, on the one hand, with means for sliding in a plane parallel to the plane of said bed and in a translational guidance direction parallel to the cutting plane of a cutting tool of said cutting machine, and, on the other hand, with means for positioning the part to be cut relative to said plane of said cutting tool in a plurality of special, defined angular positions.

2. Positioning device according to claim 1, wherein the angles formed respectively by said angular positions with the translational guidance direction are multiples of 5°

3. Positioning device according to claim 1, wherein the angular positioner is provided with facets, and said means for positioning the part to be cut comprise two of said facets perpendicular to each other, each of said two of said facets forming a special, defined angle relative to said translational guidance direction.

4. Positioning device according to claim 2, wherein the angular positioner is provided with facets, and said means for positioning the part to be cut comprise two of said facets perpendicular to each other, each of said two of said facets forming a special, defined angle relative to said translational guidance direction.

5. Positioning device according to claim 1, wherein the angular positioner comprises a concave polygonal base laterally associated at each of its cardinal points with a stop forming a polyhedron, the means for positioning the part to be cut comprising, on the one hand, edges of the concave polygon of the base and, on the other hand, facets of the polyhedron of the each of the stops which are perpendicular to each other in pairs.

6. Positioning device according to claim 5, wherein each of said edges of the concave polygon of the base forms a special, defined angle with a translational guidance direction on a guide plate, said guide plate being provided to be mounted on said bed parallel to the direction parallel to the cutting plane of a cutting tool.

7. Positioning device according to claim 6, wherein said angular positioner is provided to be mounted to slide on said guide plate.

8. Positioning device according to claim 7, wherein said angular positioner includes, to ensure its translational guidance along the guide plate, corner facets arranged on each of stops in a portion which straddles a base.

9. Positioning device according to claim 8, wherein the translational guidance direction on the guide plate is implemented by a reference plane of the angular positioner passing through one of four planes formed by said corner facets, said reference plane being selected as the nearest to said edge of the concave polygon, each stop partially straddling the base by its median plane.

10. Positioning device according to claim 8, wherein planes formed respectively by the corner facets are separated, with minimal clearance, by a distance equal to a width of the guide plate so as to enable sliding guidance of the angular positioner on the guide plate.

11. Positioning device according to claim 9, wherein planes formed respectively by the corner facets are separated, with minimal clearance, by a distance equal to a width of the guide plate so as to enable sliding guidance of the angular positioner on the guide plate.

12. Positioning device according to claim 2, wherein the angular positioner comprises a concave polygonal base laterally associated at each of its cardinal points with a stop forming a polyhedron, the means for positioning the part to be cut comprising, on the one hand, edges of the concave polygon of the base and, on the other hand, facets of the polyhedron of the each of the stops which are perpendicular to each other in pairs.

13. Positioning device according to claim 12, wherein each of said edges of the concave polygon of the base forms a special, defined angle with a translational guidance direction on a guide plate, said guide plate being provided to be mounted on said bed parallel to the direction parallel to the cutting plane of a cutting tool.

14. Positioning device according to claim 13, wherein said angular positioner is provided to be mounted to slide on said guide plate.

15. Positioning device according to claim 14, wherein said angular positioner includes, to ensure its translational guidance along the guide plate, corner facets arranged on each of stops in a portion which straddles a base.

16. Positioning device according to claim 15, wherein the translational guidance direction on the guide plate is implemented by a reference plane of the angular positioner passing through one of four planes formed by said corner facets, said reference plane being selected as the nearest to said edge of the concave polygon, each stop partially straddling the base by its median plane.

17. Positioning device according to claim 15, wherein planes formed respectively by the corner facets are separated, with minimal clearance, by a distance equal to a width of the guide plate so as to enable sliding guidance of the angular positioner on the guide plate.

18. Positioning device according to claim 16, wherein planes formed respectively by the corner facets are separated, with minimal clearance, by a distance equal to a width of the guide plate so as to enable sliding guidance of the angular positioner on the guide plate.

19. Positioning device according to claim 1, wherein legs located at each of ends of the guide plate have notches which are provided to respectively engage with teeth formed on lateral edges of the bed.

20. Positioning device according to claim 19, wherein the teeth have a trapezoidal shape.

21. Positioning device according to claim 19, wherein a pitch of the teeth is equal to three times the pitch of the notches.

22. Positioning device according to claim 20, wherein a pitch of the teeth is equal to three times the pitch of the notches.
